(19) United States
(12) Patent Application Publication
(10) Pub. No.: US 2019/0200070 A1
(43) Pub. Date: Jun. 27, 2019

(54) STREAMING METHODS AND SYSTEMS USING TUNER BUFFERS

(71) Applicant: SLING MEDIA PVT LTD, Bangalore (IN)

(72) Inventors: Yatish Jayant Naik Raikar, Bangalore (IN); Arunoday Thammineni, Bangalore (IN)

(73) Assignee: SLING MEDIA PVT LTD, Bangalore (IN)

(21) Appl. No.: 15/891,958

(22) Filed: Feb. 8, 2018

(30) Foreign Application Priority Data
Dec. 21, 2017 (IN) 201741046034

(51) Int. Cl. H04N 21/426; H04N 21/45; H04N 21/438

(52) U.S. Cl. CPC H04N 21/4263; H04N 21/4384; H04N 21/4532

(57) ABSTRACT

Methods and systems are provided for presenting media content with reduced latency. An exemplary method involves obtaining, by a tuner at a media device, media content broadcast on a broadcast channel and buffering, at the media device, a recent subset of the media content in a buffer associated with the tuner. In response to selection of the broadcast channel for presentation on a destination device coupled to the media device, the method continues by transcoding at least a portion of the buffered subset of the media content at the media device and providing the transcoded subset of the media content to the destination device.

### PRIORITY

This application claims priority to India provisional application number 201741046034, filed Dec. 21, 2017, the entire content of which is incorporated by reference herein.

### TECHNICAL FIELD

Embodiments of the subject matter described herein relate generally to multimedia distribution systems, and more particularly, to reducing latencies when transcoding and streaming broadcast multimedia content in real-time.

### BACKGROUND

Media content can now be received from any number of different sources on any number of different devices or “placeshifted” from one device to another. Media content can also be stored in a personal or digital video recorder (DVR) or the like for viewing at a later time (“time shifting”). Live or recorded media content can also be “placeshifted” to allow viewing at remote locations away from the viewer's primary television set. In practice, a viewer's set-top box or primary television set may receive broadcast media content in a bandwidth, quality, or format that is unsupported, incompatible or undesirable for placeshifting. This, in turn, may require transcoding or other processing that may undesirably increase the delay or latency between when media content is selected for presentation and when the media content is presented. Accordingly, it is desirable to improve the user experience by reducing the delays or latencies when placeshifting live media content and minimizing the time difference between when a particular piece or segment of media content is available and when the viewer actually views the piece of media content. Other desirable features and characteristics will become apparent from the subsequent detailed description and the appended claims, taken in conjunction with the accompanying drawings and the foregoing technical field and background.

### BRIEF SUMMARY

Embodiments of methods, systems, and devices for presenting media content with reduced latency are provided. An exemplary method involves obtaining, by a tuner at a media device, media content broadcast on a broadcast channel and buffering, at the media device, a recent subset of the media content in a buffer associated with the tuner. In response to selection of the broadcast channel for presentation on a destination device coupled to the media device, the method continues by transcoding, at the media device, at least a portion of the buffered subset of the media content and providing, by the media device, the transcoded subset of the media content to the destination device.

In one embodiment, an apparatus for a media device includes a tuner to receive media content on a broadcast channel, a tuner buffer coupled to the tuner to buffer a recent subset of the media content on the broadcast channel, a time shift buffer, and a management module coupled to the tuner buffer and the time shift buffer to initialize the time shift buffer with the recent subset of the media content on the broadcast channel from the tuner buffer in response to selection of the broadcast channel associated with the tuner.

In another embodiment, a media device includes a tuner arrangement comprising a plurality of tuners, a data storage arrangement comprising a plurality of tuner buffers corresponding to the plurality of tuners and a time shift buffer, and a management module coupled to the data storage arrangement to initialize the time shift buffer with a buffered subset of media content from a first tuner buffer of the plurality of tuner buffers prior to feeding the time shift buffer with the media content from a first tuner associated with the first tuner buffer in real-time in response to user selection of a broadcast channel associated with the first tuner.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 depicts a block diagram of an exemplary embodiment of a media system;

FIG. 2 is a flowchart of an exemplary live streaming process suitable for implementation by a media device in accordance with one or more embodiments;

FIG. 3 depicts a block diagram of an exemplary embodiment of a media device suitable for use in the media system of FIG. 1 in connection with the live streaming process of FIG. 2.

### DETAILED DESCRIPTION

The following detailed description of the invention is merely exemplary in nature and is not intended to limit the invention or the application and uses of the invention. Furthermore, there is no intention to be bound by any theory presented in the preceding background, brief summary, or the following detailed description.

Embodiments of the subject matter described herein generally relate to reducing latencies in presenting live broadcast media content. For purposes of explanation, the subject matter may be described herein primarily in the context of reducing latencies upon initializing the streaming or placeshifting of the content to another device over a communications network; however, it should be noted that the subject matter is not necessarily so limited, and may be implemented in an equivalent manner when presenting content on a television or other display device. As used herein, “media content,” “media program,” “multimedia content,” or variants thereof should be understood as referring to any audiovisual programming or content in any streaming, file-based or other format. The media content generally includes data that, when processed by a media player or decoder, allows the media player or decoder to present a visual and/or audio representation of the corresponding program content to a viewer (i.e., user of a device including the media player or decoder). In one or more embodiments, a media player can be realized as a piece of software that plays multimedia content (e.g., displays video and plays audio).

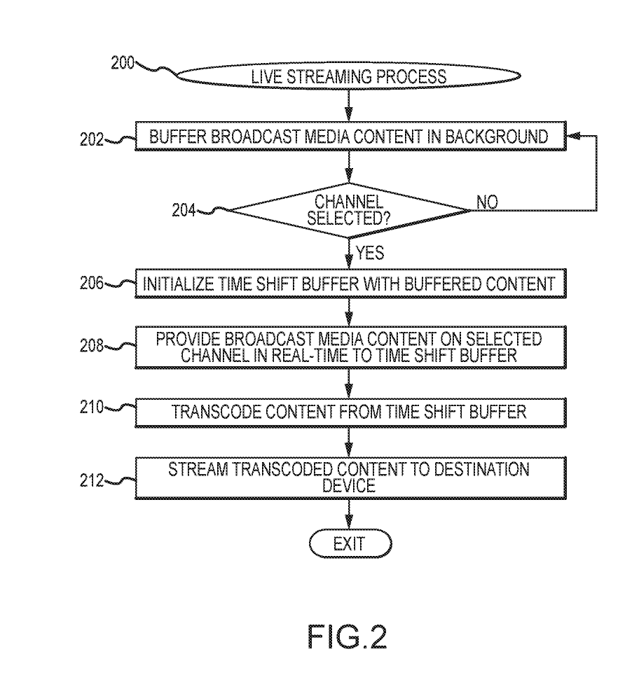

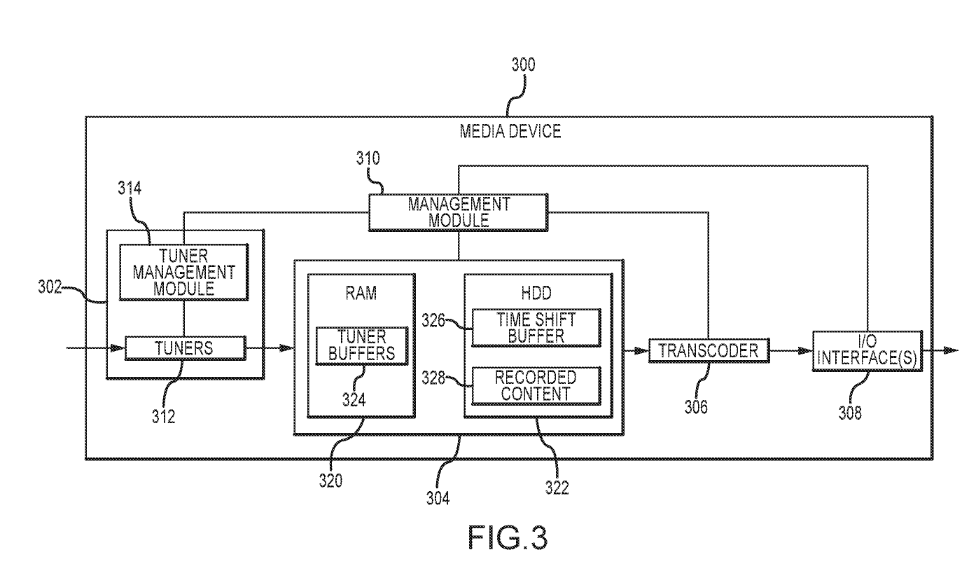

As described in greater detail below primarily in the context of FIGS. 2-3, in exemplary embodiments described herein, a media device includes dedicated buffers corresponding to the available tuners of the media device that allow received broadcast channels to be continuously buffered in the background independently of whether the media content on a respective channel is being presented. Upon selection or indication of a particular broadcast channel for presentation, a time shift buffer of the media device is initialized with the buffered media content from the respective tuner buffer prior to feeding or filling the time shift buffer with the live broadcast media content in real-time. This allows a transcoder to recognize or identify a key frame within the time shift buffer in advance of when the next key frame may appear within the live broadcast media content, and thereby transcoding the selected media content earlier, which reduces the amount of time or delay between when a broadcast channel is selected and when a transcoded version of the broadcast media content is available. As a result, presentation delay between when the broadcast channel is selected and when the media content currently being broadcast on that channel is presented is reduced, thereby improving the user experience. Additionally, by preloading or initializing the time shift buffer with media content, the transcoding may be performed at a rate that is faster than real-time, which allows for the transcoder to catch up to the live or real-time broadcast media content. Playback of the transcoded media content may also occur at a faster than real-time rate that allows for playback to catch up to the available transcoded media content to reduce the amount of lag behind live.

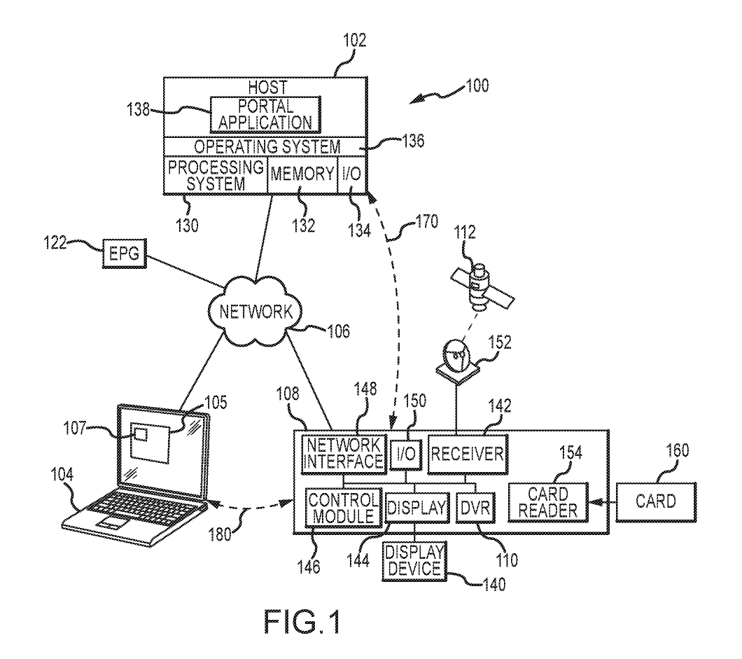

FIG. 1 depicts an exemplary embodiment of a system 100 for placeshifting or otherwise transferring data or content, such as a media program (or media content), from a source electronic device 108 to a destination electronic device 104 over a network 106 for presentation to a user (or viewer) on the destination electronic device 104. For purposes of explanation, but without limitation, the source device 108 may be alternatively referred to herein as a media device or a placeshifting device, and the destination electronic device 104 may be alternatively referred to herein as a playback device or a client device (or client). The media system 100 also includes a host server 102 (e.g., host server 110) that communicates or otherwise interacts with the devices 104, 108 over the network 106 to facilitate establishment of a peer-to-peer connection 180 over the network 106 to be utilized for a placeshifting session. It should be understood that FIG. 1 is a simplified representation of the media system 100 for purposes of explanation and is not intended to limit the subject matter described herein in any way.

In practice, the client device 104 may be any device, component, module, hardware and/or the like that is capable of communicating with the host server 102 and the media device 108 over a communications network 106. For example, depending on the embodiment, client device 104 may be realized as a conventional personal computer, portable computer, a tablet computer, workstation and/or other computing system, a mobile (or cellular) telephone, a smartphone, a personal digital assistant, a video game player, and/or any other device capable of receiving media programs via the network 106 and presenting audio and/or visual content. In this regard, the client device 104 includes a display device, such as a monitor, screen, or another conventional electronic display, capable of graphically presenting visual content, data and/or information that is generated or otherwise provided by an application 105, 107 executing on the client 104. The client device 104 may further include a user input device, such as a keyboard, a mouse, a touchscreen, or the like, capable of receiving input data and/or other information from the user of the client device 104. The client device 104 also includes a processing system and a data storage element (or memory) that is coupled to or otherwise accessed by the processing system and stores programming instructions that, when read and executed, cause the processing system of the client device 104 to generate one or more applications 105, 107 executing thereon and perform various tasks, functions, processes and/or operations and support the subject matter described herein. The processing system may be realized as any sort of processor, microprocessor, microcontroller, digital signal processor, or any other suitable processing device, or any suitable combination thereof.

The client 104 may reside at a geographic location that is remote or otherwise physically distinct from the geographic location of the media device 108. In this regard, the media device 108 may have an essentially fixed or permanent geographic location, whereas the geographic location of the client 104 may be transient or otherwise variable with respect to the location of the media device 108. For example, the media device 108 may be realized as a set-top box or a similar device that resides at a user's home for providing media content to the user's television or other home display device 140, while the client 104 is realized as a portable electronic device, such as a mobile phone or other mobile computing device, that moves about with the user.

In the illustrated embodiment shown in FIG. 1, client device 104 executes any sort of conventional browser or other client application 105 that is compatible with standard Internet, world wide web (WWW), transmission control protocol and/or internet protocol (TCP/IP), and/or other formats. Such browsers are typically capable of displaying active or other documents formatted in accordance with published protocols (e.g., hypertext markup language (HTML), extensible markup language (XML), and/or the like). Many browsers are also capable of executing “plugin” applications, applets or the like. Such plugins may be formatted in accordance with ActiveX, JAVA and/or any number of other formats. A number of commonly used web browsers are available for a number of different computing platforms, and the subject matter described herein is not limited to any particular browser application. In the illustrated embodiment, client 104 further includes a media player application 107. The media player 107 may be a standalone media player, or the media player 107 may be implemented as a plugin or other applet that runs within the client application 105 as desired. In some embodiments, media player 107 is initially obtained from a networked host, such as host server 102. The media player 107 may be retrieved on an as-needed basis in some embodiments, or may be stored at client 104 for subsequent execution.

Still referring to FIG. 1, in exemplary embodiments, the media device 108 is any device, module, component, hardware and/or the like capable of receiving and processing media content from one or more content sources. For example, in some embodiments, media device 108 is a set-top box (STB) or similar device that is able to receive television programming and/or to record certain programs that can be viewed on a display device 140, such as a television, monitor, liquid crystal display (LCD), light emitting diode (LED) display, plasma display, or the like. Exemplary embodiments of media device 108 will therefore include or otherwise be coupled to a receiver interface 142 for receiving satellite, cable and/or broadcast programming signals from broadcast content sources 112. The media device 108 may also include a data storage medium 110 (e.g., a hard disk, flash memory, or another suitable non-volatile data storage element) to support a digital video recorder (DVR) feature and/or functionality, a display interface 144 for providing imagery to the display device 140, and a control module 146 that directs the operations of the media device 108 as appropriate. For convenience, but without limitation, the data storage medium 110 is alternatively referred to herein as a DVR. Media device 108 may also include one or more interfaces 148 to the network 106 and/or an input/output interface 150 to a remote control or other device for providing user inputs to the media device 108. The network interface(s) 148 of the media device 108 may include an interface or port for a wired communications layer (e.g., an Ethernet port or adapter), an interface for a wireless communications layer (e.g., an IEEE 802.11-compatible transceiver), and/or the like.

The components in media device 108 may be provided within a common chassis or housing as depicted in FIG. 1, although equivalent embodiments may implement media device 108 with any number of inter-connected but discrete components or systems. For example, in some embodiments, the media device 108 may be realized as a combination of a STB and a placeshifting device, wherein some features of the media device 108 (e.g., the DVR 110, the receiver 142, the display interface 144, and/or I/Os 150) are implemented by the STB and other features of the media device 108 (e.g., the network interface 148) are implemented by the placeshifting device, wherein the placeshifting device works in conjunction with the STB to shift the viewing experience from a home television (e.g., display device 140) to a viewing display on the client device 104 that is accessed via the network 106. Many different types of placeshifting devices are generally capable of receiving media content from an external source, such as any sort of DVR or STB, cable or satellite programming source, DVD player, and/or the like. In other embodiments, placeshifting features are incorporated within the same device that provides content-receiving or other capabilities. Media device 108 may be a hybrid DVR and/or receiver, for example, that also provides transcoding and placeshifting features. It should be appreciated that FIG. 1 depicts merely one exemplary embodiment of a media device 108, and in practice, the media device 108 may be logically and physically implemented in any manner to suit the needs of a particular embodiment.

In the exemplary embodiment illustrated in FIG. 1, media device 108 is capable of receiving digital broadcast satellite (DBS) signals transmitted from a broadcast source 112, such as a satellite, using an antenna 152 that provides received signals to the receiver 142. Equivalent embodiments, however, could receive programming at receiver 142 from any sort of cable connection, broadcast source, removable media, network service, external device and/or the like. In some embodiments, the media device 108 may also include an access card interface or card reader 154 adapted to receive an access card 160 (or viewing card) configured to ensure that the viewer is authorized to view media content provided to the display device 140. In this regard, the access card 160 includes unique identification information associated with a particular subscriber to the broadcast content source 112 or otherwise includes subscription information that facilitates receiving and/or decoding media content provided by the broadcast content source 112.

The DVR 110 feature stores recorded programming (e.g., recorded broadcast programming received via receiver 142) on a hard disk drive, memory, a networked server, or other storage medium as appropriate in response to user/viewer programming instructions, wherein the recorded programming may be subsequently viewed via the media device 108, either on display device 140 or client device 104 via network 106. Content stored in DVR 110 may be any sort of file-based programming or other content that is accessible to media device 108. In various embodiments, in addition to storing broadcast programming, the DVR 110 may also store programming received from other sources not illustrated in FIG. 1, such as, for example, programming downloaded from an on-demand programming source or an online programming source. Additionally, content in DVR 110 may be stored in any sort of compressed or uncompressed format, as desired, and may be encoded or transcoded as desired for effective receipt, storage, retrieval and playing.

The control module 146 is any sort of hardware, circuitry, processing logic and/or other components capable of directing the operations of media device 108. In various embodiments, control module 146 includes software or firmware logic and/or other programming instructions residing in memory and executing on any sort of processing system, such as any sort of processor, microprocessor, microcontroller, digital signal processor or the like. The instructions, when read and executed, cause the control module 146 to perform various tasks, functions, processes and/or operations and otherwise support the subject matter described herein. In various embodiments, the control module 146 is based upon a “system on a chip” (SoC) implementation that incorporates a hybrid microcontroller with memory, input/output and other features to perform the various signal processing and other actions of media device 108. Other embodiments may implement control module 146 and/or the other features of media device 108 with any number of discrete and/or integrated processing components (e.g., any sort of microprocessor or microcontroller), memories, input/output features and/or other features as desired. The control module 146 communicates with the network interface 148 to establish a peer-to-peer connection 180 to the client device 104 over the network 106 and support streaming of media programs (e.g., from the DVR 110 or the receiver 142) to the client device 104 over the network 106 via the peer-to-peer connection 180, as described in greater detail below.

In the embodiment of FIG. 1, the network 106 is any communications network (or a combination of communications networks) capable of transmitting data between devices within the system 100. In various embodiments, network 106 includes any number of public or private data connections, links or networks supporting any number of communications protocols. Network 106 may include the Internet, for example, or any other network. Such networks may be based upon TCP/IP or other conventional protocols, although other embodiments may use any type of alternate or successor protocols, as desired. In various embodiments, network 106 may also incorporate a wireless and/or wired telephone network, such as a cellular communications network for communicating with mobile phones, personal digital assistants, and/or the like. Various embodiments of network 106 may also incorporate any sort of wireless or wired local area networks (LANs), wide area networks (WAN), a fixed wireless network, a low power wide area network (LPWAN), a narrowband Internet of Things (NB-IoT) network, or other network supporting a Long-Term Evolution (LTE) standard or fifth generation (5G) standard, or the like.

In the illustrated embodiment of FIG. 1, the host server 102 may be realized as one or more server computers or other device(s) coupled to the network 106 and capable of interacting with the devices 104, 108 to facilitate communications between the client device 104 and the media device 108 associated with the user or operator of the client 104. The host server 102 may be implemented with a server computer system or data processing system that is based upon any processor, architecture and/or operating system, and will typically be implemented using any sort of processing system 130, memory 132 and input/output features 134. Various embodiments may be implemented using dedicated or shared hardware servers; other implementations may make use of virtual server features as part of a “cloud computing” service, such as any of the cloud computing services provided by any number of providers. Although FIG. 1 shows a single server 102 for convenience, many practical embodiments of the system 100 may provide a cluster or other collection of multiple host servers 102 to support any desired number of simultaneous communications with multiple clients 104 and/or multiple media devices 108. This cluster may also incorporate appropriate routing, load balancing, access and security mechanisms and or any number of other features. In various embodiments, each host server 102 is an actual or virtual computer system executing an operating system 136 in conjunction with the processing system 130, memory 132 and/or I/O features 134 to provide a computing core that is capable of executing a portal application 138, as well as any number of daemons, processes, applications or other modules as desired. For example, a portal application 138 could execute as a daemon on the host server 102, with connections to separate clients 104 being managed as separate processes or instances that communicate with portal application 138 using features provided by operating system 136. In one or more embodiments, the memory 132 stores programming instructions that, when read and executed, cause the processing system 130 to create, generate, or otherwise facilitate the portal application 138 and perform various tasks, functions, processes and/or operations described herein. In this regard, the memory 132 represents any non-transitory short or long term data storage element or other computer-readable media capable of storing programming instructions for execution by or on the processing system 130.

The user of the client 104 is able to connect to the portal application 138 supported by host 102 via the network 106, for example, by directing the client application 105 to a URL or other network address associated with host 102 and/or portal application 138. In exemplary embodiments, after the user is successfully authenticated by the portal application 138, the host 102 and/or portal application 138 establishes a connection 170 over the network 106 to the media device 108 that is associated with the user. Thereafter, the host 102 and/or the portal application 138 utilizes the connection 170 to obtain, from the media device 108 via the network 106, information about programming stored at the media device 108 and available for placeshifting to the client device 104, such as, for example, a listing of the media programs stored on DVR 110.

In one or more exemplary embodiments, the host server 102 is coupled to an electronic program guide 122, which may be realized as a server, a database, or another device operating on the network 106 that maintains information pertaining to current and/or future broadcasts (or airings) of media programs that are available to be received from broadcast source 112 (e.g., by the media device 108 via receiver 142 and/or antenna 152). The host server 102 and/or the portal application 138 may obtain information pertaining to current and/or future broadcasts (or airings) of media programs from the electronic program guide 122 and generate or otherwise provide a program guide graphical user interface (GUI) display on the client device 104 (e.g., within client application 105) that indicates media programs that are or will be available for streaming from the media device 108. The user of the client device 104 may manipulate or otherwise utilize the graphical user interface (or the graphical user interface elements contained therein) to select or otherwise identify media programs or broadcast channels for streaming to the client device 104 and/or recording to the DVR 110.

A user may manipulate the client application 105 to contact or otherwise access the portal application 138 via the network 106 and attempt to login to the portal application 138. The portal application 138 may receive or otherwise obtain a user identifier (or subscriber identifier) associated with the client device 104 and identify authentication information corresponding to that user identifier. For example, the user of the client device 104 may input or otherwise provide a username that the user has previously registered with the host server 102 and/or the portal application 138, where the authentication information is realized as a password associated with that username that was set by a subscriber associated with the media device 108 when registering with the portal application 138 and stored or otherwise maintained on the host server 102. In other embodiments, the authentication information may be stored on the media device 108 and/or the access card 160 and retrieved by the host server 102 and/or the portal application 138 via the connection 170 over the network 106.

After the user is successfully authenticated by the portal application 138, the host 102 and/or portal application 138 may establish the connection 170 over the network 106 to the media device 108 and utilize the connection 170 to obtain, from the media device 108 via the network 106, information about programming stored at the media device 108 and available for placeshifting to the client device 104, such as, for example, a listing of the media programs stored on DVR 110. It should be noted that although FIG. 1 depicts the network connection 170 as being between the host 102 and the media device 108, in practice, the media system 100 may include one or more intermediary components (e.g., one or more message servers) configured to establish, facilitate, or otherwise support the connection 170.

In some embodiments, the host 102 and/or portal application 138 present a GUI display on the client device 104 (e.g., within the client application 105) that includes a program guide listing media programs and corresponding broadcast channels available for placeshifting by the user. The user may manipulate one or more GUI elements of the GUI display to select or otherwise indicate the broadcast channel or broadcast media program that the user would like to placeshift to the client device 104. In response to receiving a placeshifting request for a broadcast media program from the client 104, the host 102 and/or the portal application 138 transmits or otherwise provides streaming instructions for the selected media program to the media device 108 over the network 106 (e.g., via connection 170). In this regard, the streaming instructions identify the client device 104 as the destination device for the placeshifting session along with the requested broadcast channel for the placeshifting session. In response to the streaming instructions, the media device 108 automatically initiates the peer-to-peer connection 180 over the network 106 with the client 104. After communicating with the client device 104 to establish the peer-to-peer connection 180, the media device 108 automatically transfers or streams the requested media program from the broadcast content source 112 to the media player 107 within the client application 105 on the client 104.

As described in greater detail below in the context of FIG. 2, in exemplary embodiments, the receiver interface 142 of the media device 108 includes a plurality of different tuners that allow the media device 108 to receive multiple different broadcast channels concurrently. The media device 108 includes (e.g., as part of data storage element 110) a plurality of different buffers associated with respective ones of the tuners that allow the media device 108 to concurrently buffer broadcast media content from the different tuners in the background independently of whether or not the particular tuner or broadcast channel is being presented. For example, each tuner of the receiver interface 142 may include a dedicated buffer associated therewith that buffers or otherwise stores a most recent subset of the media content broadcast on that respective broadcast channel in a first in, first out (FIFO) manner. In one or more embodiments, the duration of media content buffered in the respective tuner buffers is greater than or equal to the maximum duration of time between key frames of broadcast media content received at the media device 108. For example, in one or more embodiments, broadcast media content may include an I-frame (or intra-coded frame) every one to three seconds, and the tuner buffers are configured to buffer at least three seconds of media content.

In response to selection of a particular broadcast channel for the placeshifting request that is currently being buffered at the media device 108 in the background, the media device 108 initializes a time shift buffer or similar presentation buffer at the media device 108 with the pre-buffered media content from the tuner buffer associated with the tuner currently configured to receive the selected broadcast channel before subsequently feeding or filling the time shift buffer with the live broadcast media content on the selected broadcast channel in real-time. The media device 108 may automatically begin analyzing the pre-buffered media content used to initialize the time shift buffer to identify a key frame (or I-frame) contained therein that allows the media device 108 to begin transcoding the media content in the time shift buffer prior to receiving or detecting a subsequent key frame (or I-frame) in the live broadcast media content. Thus, transcoded media content corresponding to the selected broadcast channel or media program is available at the media device 108 earlier than it otherwise would have been in the absence of the pre-buffered media content, which, in turn allows for the selected broadcast channel or media program to be placeshifted to and presented at the client device 104 earlier.

In exemplary embodiments, the pre-buffered media content is transcoded at a rate that is faster than real-time (or super real-time transcoded), thereby further reducing latency. For example, if the transcoder is capable of transcoding at four times (or 4×) real-time transcoding speed given the resolution and bitrate requested for presentation by the client 104, one second of pre-buffered media content can be transcoded in 0.25 seconds. In some embodiments, the transcoder at the media device 108 is configured to transcode at a faster than real-time transcoding rate until reaching the most recent key frame or I-frame indicating the transcoder has caught up to the live broadcast media content, thereby allowing the media device 108 to temporarily provide transcoded media content to the client device 104 at a faster rate than during streaming live content in real-time. Additionally, when transcoded media content is being received at a faster than real-time rate or sufficient transcoded media content is otherwise available for presentation, the media player 107 at the client device 104 may playback the transcoded media content at a faster than real-time playback rate until catching up to the live broadcast media content, thereby reducing the amount by which presentation of the selected broadcast channel lags behind live (e.g., the time difference between when a frame or segment of content is received at the media device 108 and when it is presented at the client device 104).

FIG. 2 depicts an exemplary embodiment of a live streaming process 200 suitable for implementation by a media device in a media system, such as the media device 108 in the media system 100 of FIG. 1, to present live broadcast media content with reduced latency upon initialization. The various tasks performed in connection with the illustrated process 200 may be implemented using hardware, firmware, software executed by processing circuitry, or any combination thereof. For illustrative purposes, the following description may refer to elements mentioned above in connection with FIG. 1. In practice, portions of the live streaming process 200 may be performed by different elements of a media system 100. That said, for purposes of explanation, the live streaming process 200 is described here in the context of primarily being performed by the media device 108. It should be appreciated that the live streaming process 200 may include any number of additional or alternative tasks, the tasks need not be performed in the illustrated order and/or the tasks may be performed concurrently, and/or the live streaming process 200 may be incorporated into a more comprehensive procedure or process having additional functionality not described in detail herein. Moreover, one or more of the tasks shown and described in the context of FIG. 2 could be omitted from a practical embodiment of the live streaming process 200 as long as the intended overall functionality remains intact.

The live streaming process 200 initially buffers media content broadcast live on multiple different broadcast channels in real-time until receiving selection or indication of one of those broadcast channels for presentation (tasks 202, 204). In exemplary embodiments, the media device 108 includes a plurality of different tuners, with each of the tuners being configured to parse or separate a received transmission stream into a media content stream corresponding to a particular broadcast channel. Each of the tuners is associated with a corresponding buffer or similar data storage element that stores or otherwise maintains a recent subset of the media content broadcast on the respective channel. In exemplary embodiments, the duration of time for the recent subset of the media content maintained in the buffer is greater than or equal to the maximum amount of time between key frames (or I-frames) within the broadcast media content streams received by the antenna 152. For example, if the broadcast content source 112 broadcasts media content streams with key frames every 3 seconds, the tuner buffers may be configured to buffer at least 3 seconds of broadcast media content on a particular broadcast channel. In exemplary embodiments, the tuner buffers buffer broadcast media content in a FIFO manner, so that only a most recent subset of the broadcast media content is maintained in the buffer as older broadcast media content is continually evicted. In this manner, the tuner buffers operate in the background to continually buffer media content broadcast on different broadcast channels.

In exemplary embodiments, a first tuner of the media device 108 may be configured by the control module 146 of the media device 108 to receive a broadcast media channel current being presented by the media device 108 on the display device 140 and/or client device 104, with the remaining tuners being allocated according to user preferences, popularity, or the like. For example, based on the viewing history associated with a user of the client device 104 or a viewing history associated with the media device 108, the control module 146 may identify or otherwise determine which broadcast channels are most frequently or commonly viewed by the user or presented by the media device 108, and then automatically configure the tuners of the media device 108 to receive a subset of the most frequently viewed broadcast channels. For example, if the receiver interface 142 of the media device 108 includes 4 tuners, the control module 146 may configure a first tuner to tune or receive a broadcast channel currently (or most recently) presented on the display device 140, and configure the remaining 3 tuners to tune or receive the 3 broadcast channels most frequently viewed by the user (excluding the broadcast channel received by the first tuner) in the background. Additionally or alternatively, the control module 146 may receive indication from the host server 102 that indicates broadcast channels that the tuners should be configured for. For example, the host server 102 may receive indication of the broadcast media channel currently being presented by a plurality of different media devices 108 and/or receive viewing histories from different media devices 108, and the host server 102 may then analyze the current viewing behaviors and/or various viewing histories for different users to determine popularity metrics associated with individual broadcast channels or otherwise identify or determine which broadcast channels are most likely to be of interest to the user associated with a particular media device 108. In this regard, the host server 102 may utilize machine learning or other artificial intelligence techniques to predict what broadcast channels a user of a media device 108 is likely to be interested in based on the user's demographic data, the current time of day, the current day of the week, and/or other contextual factors. In this regard, some embodiments may utilize channel popularity data or metrics to augment the broadcast channels identified for buffering by the media device 108. For example, if the media device 108 includes 16 different tuners but the user frequently only views 8 different broadcast media channels, broader population data may be utilized to identify and configure the remaining 8 tuners for other broadcast media channels most likely to be of interest based on popularity metrics, trends, demographics, and/or the like.

Still referring to FIG. 2, in response to selection of one of the broadcast media channels being buffered in the background for presentation, the illustrated live streaming process 200 initializes a time shift buffer utilized for presentation with the buffered broadcast media content in the tuner buffer associated with the selected broadcast media channel before feeding or providing the live broadcast media content on the selected broadcast media channel to the time shift buffer in real-time (tasks 206, 208). In this regard, the time shift buffer is cleared or otherwise emptied before transferring or loading the most recent subset of the broadcast media content from the tuner buffer to the time shift buffer. The broadcast media content stream output by the tuner associated with the selected broadcast channel is then fed or otherwise provided to the time shift buffer following the preloaded and prebuffered subset of the broadcast media content stream. Thus, the recent subset of the broadcast media content preceding the live real-time broadcast is queued or otherwise ordered for presentation in advance of the live broadcast data. The time shift buffer is then continually filled with more recent live broadcast media content in real-time while the selected broadcast channel is presented.

The live streaming process 200 continues by transcoding or otherwise converting the broadcast media content from the time shift buffer for subsequent transmission and presentation and then streaming or otherwise transmitting the transcoded broadcast media content to the appropriate destination device for presentation (tasks 210, 212). In this regard, a transcoder of the media device 108 (which may be implemented as part of the control module 146 or the display interface 144) parses or analyzes the data in the time shift buffer from the start of the time shift buffer to identify the earliest or oldest key frame (or I-frame) that provides reference for decoding and re-encoding the buffered media content from the broadcast format to a different format for placeshifting, transmission, or other presentation. Once the key frame is identified, the transcoder begins decoding the broadcast media content data in the time shift buffer from that point in a FIFO manner and then re-encodes the decoded broadcast media content data into a different format suitable for placeshifting or presentation.

For example, in one embodiment, the broadcast media content could be initially received by the media device 108 on the broadcast channel in a broadcasting standard or format, such as a Digital Video Broadcasting-Satellite standard (e.g., DVB-S, DVB-S2, DVB-S2x), a direct broadcast satellite (DBS) standard, or other proprietary standard associated with the satellite provider, a terrestrial broadcast standard (e.g., in accordance with an Advanced Television Systems Committee (ATSC) standard), or some other broadcast format, with the transcoder of the media device 108 converting the received broadcast media content into a media content transport stream formatted in accordance with a Moving Picture Experts Group (MPEG) standard, such as a MPEG-4 transport stream, a MPEG-2 transport stream, or a content stream formatted in accordance with H.264 (e.g., MPEG-4 Part 10 or Advanced Video Coding), advanced audio coding (AAC), HTTP Live Streaming (HLS), or another suitable coding format. Additionally, in some embodiments where the broadcast media content is being placeshifted, streamed, or otherwise retransmitted over a communications network 106, the transcoder may also further encode or encapsulate the transcoded broadcast media content in accordance with a communications protocol, such as, for example, Internet Protocol version 4 (IPv4), Internet Protocol version 6 (IPv6), or another suitable Transmission Control Protocol (TCP) or IP format. After transcoding the broadcast media content in the time shift buffer, the media device 108 transmits or otherwise provides the transcoded broadcast media content to the appropriate destination device 104, 140 for presentation.

It should be noted that in some embodiments, rather than loading the buffered media content to the time shift buffer, the buffered media content for the selected broadcast channel may be read and transcoded directly from the tuner buffer without loading or transferring the buffered media content to the time shift buffer. Additionally, in some embodiments, the media device 108 may implement a key frame parser (or I-frame parser) that is configured to analyze the buffered media content to locate key frames independent of the transcoder and before loading the time shift buffer, so that non-key frames or orphan frames preceding the oldest (or earliest) key frame in the tuner buffer are excluded or otherwise not provided to the time shift buffer or the transcoder, thereby further reducing the time required for the transcoder to identify an initial key frame by eliminating non-key frames from the start of the data fed to the transcoder.

In exemplary embodiments, the transcoder at the media device 108 is configured to initially transcode media content in the time shift buffer at a faster than real-time rate until reaching a live data pointer or most recent key frame in the time shift buffer. In this regard, the transcoder is capable of transcoding a duration of time worth of media content in the time shift buffer that is greater than the duration of time required to perform the transcoding. By way of example, a transcoder capable of operating at twice (or 2×) a real-time transcoding rate may transcode two seconds worth of media content in one second, a transcoder capable of operating at four times (or 4×) the real-time transcoding rate may transcode one second worth of media content in 0.25 seconds, and so on. Thus, the transcoder may progress through the media content data in the time shift buffer at a rate that is faster than the rate at which new media content data is being added to the time shift buffer until reaching the most recent or final key frame in the time shift buffer, at which point the transcoder may revert to a real-time transcoding rate. It should also be noted that adaptive playback rates may also be utilized by the media player 107 at the client device 104 to present the transcoded media content at a faster than real-time rate to minimize the amount of time presentation at the client device 104 lags behind the receipt of the real-time live broadcast media content at the client device 104 once the transcoder at the media device 108 catches up to the live data pointer or most recent key frame of the received broadcast media content.

In some embodiments of the live streaming process 200, the media device 108 may also be capable of outputting or transmitting transcoded media content at a faster than real-time rate, thereby further reducing the latency associated with initiating playback. For example, if one second of media content is transcoded at 4 megabits per second (Mbps) and the available bandwidth to the media device 108 on the network 106 is 8 Mbps, the media device 108 may transmit one second worth of transcoded media content to the client device 104 via the network 106 in half a second. Thus, for an embodiment where one second worth of transcoded media content can be transcoded into a 4 Mbps content stream at four times the real-time transcoding rate and transmitted at twice a real-time transmission rate, the amount of latency or delay between content selection and presentation associated with transcoding and transmitting the one second worth of media content by the media device 108 is 0.75 seconds. Assuming 0.1 seconds is required to transfer content from the tuner buffer to the time shift buffer and start decoding, the total latency at the media device 108 upon channel selection is 0.85 seconds. Conversely, for live streaming that does not incorporate tuner buffering and relies on real-time transcoding and real-time streaming after identifying the next key frame in the broadcast media content stream, the amount of latency or delay between content selection and presentation associated with transcoding and transmitting the one second worth of media content by the media device 108 could range from 1.5 seconds to 2 seconds. Assuming an amount of time before the next key frame is identified that could range from 1 to 3 seconds, the total latency at the media device 108 upon channel selection could be anywhere from 2.5 seconds to 5 seconds. Thus, the total reduction in latency by virtue of the live streaming process 200 could range from anywhere from 1.15 seconds to 4.15 seconds for this example.

FIG. 3 depicts an exemplary embodiment of a media device 300 suitable for use in a media system (e.g., as the media device 108 in the system 100 of FIG. 1) to support the live streaming process 200 of FIG. 2. The media device 300 includes, without limitation, a tuner arrangement 302, a data storage arrangement 304, a transcoding module 306 (or transcoder), one or more input/output interfaces 308, and a device management module 310.

The tuner arrangement 302 generally represents the hardware, firmware, logic, circuitry, and/or other components configured to support receiving media content from respective broadcast channels available from a broadcast source or broadcast distribution network. The illustrated embodiment includes a plurality of tuners 312 and a tuner management module 314 coupled to each of the tuners 312. Each of the tuners 312 is coupled to an antenna (e.g., antenna 152) or similar receiver element to receive broadcast signals (e.g. DBS signals) and configured to parse or separate packets corresponding to a selected broadcast channel or media program from the multiplexed transmission stream corresponding to the received broadcast signals. The output of the tuners 312 then corresponds to demultiplexed packets corresponding to the broadcast channel for which the respective tuner 312 is configured to receive. The tuner management module 314 generally represents the hardware, circuitry, processing logic and/or other components capable of managing how the tuners 312 are allocated and which broadcast channels are being tuned or otherwise received by the respective tuners 312. The tuner management module 314 may be realized using any sort of processor, microprocessor, microcontroller, digital signal processor, or any other suitable processing device, or any suitable combination thereof.

In exemplary embodiments, the data storage arrangement 304 includes a first data storage element 320 that supports dedicated tuner buffers 324 associated with each of the respective tuners 312 and a second data storage element 322 that supports a time shift buffer 326 utilized to present, transmit, or otherwise provide media content corresponding to a selected broadcast channel. Additionally, in the illustrated embodiment, the second data storage element 322 stores or otherwise maintains recorded media content 328 to support DVR functionality. In one or more embodiments, the first data storage element 320 is realized using random access memory (RAM) and the second data storage element 322 is realized using a hard disk drive (HDD).

The tuner buffers 324 generally represent subsets of the first data storage element 320 that are allocated or otherwise assigned to a respective one of the tuners 312. For example, in one embodiment, the media device 300 includes 16 tuners 312, with each of the tuners 312 including a corresponding tuner buffer 324 for a total of 16 tuner buffers 324. In exemplary embodiments, each of the tuner buffers 324 is configured as a FIFO buffer that temporarily buffers, stores, or otherwise maintains a most recent subset of media content aired or broadcast on the respective broadcast channel being tuned or received by its associated tuner 312. For example, in one embodiment, the tuner buffers 324 are configured to buffer the most recent 5 seconds of the broadcast media content on a respective broadcast channel. The time shift buffer 326 generally represents a subset of the second data storage element 326 that stores or otherwise maintains data corresponding to the media program or content currently being presented, transmitted or otherwise provided by the media device 300 to a display (e.g., display device 140) or other destination device (e.g., client device 104) in a manner that allows the viewer to pause, rewind, or otherwise shift the presentation of the media content temporally.

The transcoder 306 generally represents the hardware, circuitry, processing logic and/or other components configured to support converting the media content in the time shift buffer 326 into a different format for purposes of subsequent presentation or transmission. In this regard, the transcoder 306 may be realized using any sort of processor, microprocessor, microcontroller, digital signal processor, or any other suitable processing device, or any suitable combination thereof. The output of the transcoder 306 is coupled to an I/O interface 308 that supports transmitting or otherwise providing the transcoded media content to a desired destination device. In this regard, it should be noted that when the media device 300 is utilized to present a selected broadcast channel on a television directly (e.g., by connecting the I/O interface 308 to the display device 140), the transcoder 306 may function as a decoder (or alternatively, a decoder may be utilized in lieu of the transcoder 306) that decodes the media content in the time shift buffer 326 into a displayable format without re-encoding or transcoding the media content into another encoded format.

The device management module 310 generally represents the control module of the media device 300 that is coupled to the tuner arrangement 302, the data storage arrangement 304, the transcoder 306, and the I/O interface(s) 308 and configured to support the live streaming process 200 of FIG. 2. Depending on the embodiment, the device management module 310 may be implemented or realized with a general purpose processor, a microprocessor, a controller, a microcontroller, a state machine, a content addressable memory, an application specific integrated circuit, a field programmable gate array, any suitable programmable logic device, discrete gate or transistor logic, discrete hardware components, or any combination thereof, designed to perform the functions described herein. The device management module 310 may also include or otherwise access a data storage element or memory, including any sort of RAM, read only memory (ROM), flash memory, registers, hard disks, removable disks, magnetic or optical mass storage, or any other short or long term storage media or other non-transitory computer-readable medium, which is capable of storing programming instructions for execution by the device management module 310. The computer-executable programming instructions, when read and executed by the device management module 310, cause the device management module 310 to perform or otherwise support the tasks, operations, functions, and processes described herein.

Referring again to FIG. 2, and with continued reference to FIG. 3, to support the live streaming process 200, the tuner buffers 324 are utilized to initially buffer media content broadcast live on multiple different broadcast channels in real-time until receiving selection or indication of one of those broadcast channels for presentation (e.g., tasks 202, 204). In this regard, in one or more exemplary embodiments, the device management module 310 and the tuner management module 314 are cooperatively configured to support the live streaming process 200 by determining which broadcast channels are most likely to be of interest to a user associated with the media device 300 and then allocating one or more tuners 312 of the tuner arrangement 302 to those channels. For example, the device management module 310 may be configured to receive recording instructions from a user and provide corresponding instructions to the tuner management module 314 to allocate one or more of the tuners 312 to the broadcast channels to be recorded to the DVR associated with the media device 300 (e.g., recorded content storage 328). Additionally, the device management module 310 may instruct the tuner management module 314 to configure one of the tuners 312 to a broadcast channel to be currently presented by the media device 300. For remaining tuners 312 that are not allocated or assigned to a broadcast channel currently being recorded or presented, the tuner management module 314 and/or the device management module 310 may determine how to allocate those tuners 312 based on the user's viewing history, the current context (e.g., time of day, day of week, or the like), and/or other factors, such as real-time popularity metrics.

For example, based on the user's viewing history, the current context, and/or other factors, the tuner management module 314 and/or the device management module 310 may calculate or otherwise determine a probability metric representing the likelihood of the user viewing each of the broadcast channels available at the media device 300, rank, prioritize, or otherwise order the broadcast channels according to their associated viewing probabilities, and then allocate the 16 tuners 312 of the media device 300 to the 16 highest ranked broadcast channels corresponding to the broadcast channels the user is most likely to be interested in viewing. In this regard, machine learning or other artificial intelligence techniques may be utilized to model the viewing behavior of the user and determine relative probabilities associated with various broadcast channels available at the media device 300. Thus, one or more of the tuner buffers 324 may be continually buffering broadcast channels that the user is likely to be interested in viewing.

Still referring to FIGS. 2-3, in response to selection of one of the broadcast media channels being buffered in the background for presentation, in exemplary embodiments, the device management module 310 is configured to initialize the time shift buffer 326 with at least some of the buffered broadcast media content in the tuner buffer 324 associated with the selected broadcast media channel before feeding or providing the live broadcast media content on the selected broadcast media channel from the respective tuner 312 to the time shift buffer 326 in real-time (e.g., tasks 206, 208). For example, in response to the device management module 310 receiving (e.g., via an I/O interface 308) an indication of a selected broadcast channel currently being buffered in the background using a tuner buffer 324 for placeshifting or presentation, the device management module 310 may clear, empty, or otherwise reset the time shift buffer 326 before reinitializing the time shift buffer 326 with buffered media content from the tuner buffer 324 associated with the selected broadcast channel. The device management module 310 then configures the time shift buffer 326 to be fed, loaded, or otherwise written to in real-time from the tuner 312 associated with the selected broadcast channel following the previously buffered subset of the broadcast media content stream. Thus, the recent subset of the broadcast media content preceding the live real-time broadcast (e.g., the 5 seconds of the broadcast media content in the tuner buffer 324 preceding the live pointer) is queued or otherwise ordered for presentation in advance of the live broadcast data, with the time shift buffer 326 then being continually filled with more recent live broadcast media content from the tuner 312 in real-time while the selected broadcast channel is presented.

In one or more embodiments, the transcoder 306 parses or analyzes by prebuffered broadcast media content used to initialize the time shift buffer 326 from the initial or starting location in the time shift buffer 326 until identifying a key frame within the buffered broadcast media content. Once the key frame is identified, the transcoder 306 begins decoding the broadcast media content data in the time shift buffer 326 from that point in a time sequential manner and then re-encodes the decoded broadcast media content data into a different format suitable for placeshifting or presentation via an I/O interface 308. For example, once an I-frame is identified within buffered broadcast media content, the transcoder 306 begins decoding the broadcast media content in the time shift buffer 326 from the broadcasting format (e.g., DVS-B, DBS, ATSC, or the like) and then encodes the decoded broadcast media content into a transport or presentation format (e.g., MPEG-4, MPEG-2, AAC, HLS, IPv4, IPv6, or the like). The transcoded media content output by the transcoder 306 is provided to an output interface 308 that provides the transcoded media content to the appropriate destination device for presentation.

In one or more exemplary embodiments, after initializing the time shift buffer 326 with buffered media content from a tuner buffer 324, the device management module 310 automatically commands, signals, or otherwise instructs the transcoder 306 to perform transcoding of the content in the time shift buffer 326 at a faster than real-time transcoding rate. For example, the device management module 310 may instruct the transcoder 306 to transcode the content in the time shift buffer 326 at its maximum transcoding rate. In response, the transcoder 306 sequentially transcodes the media content in the time shift buffer 326 from the initial key frame identified within the buffered media content at a faster than real-time rate until reaching a live data pointer or the most recent key frame in the time shift buffer 326. In this regard, once the transcoder 306 reaches the last available key frame in the time shift buffer 326, the transcoding rate reverts to a real-time transcoding rate.

Similarly, the device management module 310 may automatically command, signal, or otherwise instruct the output interface 308 to transmit the transcoded media content output by the transcoder 306 at a faster than real-time rate while the transcoder 306 is transcoding at a faster than real-time rate. For example, the device management module 310 may instruct, command, or otherwise configure an output interface 308 to transmit transcoded media content at a maximum data rate supported by the output interface 308 or a maximum data rate or bandwidth available on a network (e.g., network 106) that the output interface 308 is coupled to. Thus, transcoded media content may be expeditiously provided to the appropriate destination device while the transcoder 306 is lagging behind the live broadcast data in the time shift buffer 326. Once the transcoder 306 reaches the last available key frame in the time shift buffer 326 and reverts to a real-time transcoding rate, the transmission of the transcoded content is constrained to the real-time transcoding data rate. Accordingly, in some embodiments, the device management module 310 may instruct, command, or otherwise configure the output interface 308 to transmit transcoded media content at a real-time data rate.

By initializing the time shift buffer 326 with buffered data for a media program currently being broadcast in real-time on a broadcast channel, the latency perceived by a viewer between when that broadcast channel is selected by the viewer and when the viewer is presented with audiovisual content of the media program currently being broadcast on that selected channel is reduced. For example, when the media device 300 is being utilized to present a selected broadcast channel on a television (e.g., display device 140), the transcoder 306 does not need to wait until a key frame is identified within the live broadcast media content received from the tuner 312 after selection of the broadcast channel, but rather, the transcoder 306 can begin decoding using an earlier key frame within the buffered data for the selected broadcast channel. Thus, the delay between channel selection and content presentation that could otherwise be as long as 3 seconds depending on the spacing of key frames or I-frames within the broadcast content stream (plus some additional transcoding delay time) may instead be reduced or limited to the amount of time required for the buffered channel content to be transferred to the time shift buffer 326 and decoded (which could also be done at a faster than real-time rate). For example, if I-frames are spaced apart within a broadcast content stream in one second intervals, there may be a delay of up to a 2 seconds in presenting the media program currently being broadcast on the selected channel after selection (e.g., one second delay to locate an I-frame and another second of delay to transcode the media content at a real-time transcoding rate). Conversely, only a fractional delay of less than a second may be experienced when presenting the media program currently being broadcast on the selected channel if the buffered channel content can be transcoded at a faster than real-time rate and substantially immediately upon channel selection.

When the media device 300 is being utilized to placeshift a selected broadcast channel to another device on a network (e.g., client device 104), the transcoder 306 similarly does not need to wait until a key frame is identified within the live broadcast media content received from the tuner 312 after selection of the broadcast channel, and the transcoder 306 can begin transcoding using an earlier key frame within the buffered data for the selected broadcast channel. Furthermore, in addition to transcoding at a faster than real-time transcoding rate, the transcoded media content may also be placeshifted at a faster than real-time data transfer rate, at least initially if sufficient network bandwidth exists, thereby further reducing the delay between channel selection and content presentation. For example, if I-frames are spaced apart within a broadcast content stream in one second intervals, there may be a delay of up to 3 seconds in presenting the media program currently being broadcast on the selected channel at the destination device 104 after selection (e.g., one second delay to locate an I-frame, another second of delay to transcode the media content at a real-time transcoding rate, and another second of delay to transmit the media content at a real-time data transfer rate). Again, only a fractional delay of less than a second may be experienced when the buffered channel content can be transcoded and transmitted at a faster than real-time rate and substantially immediately upon channel selection.

It should be understood that FIG. 3 is a simplified representation of the media device 300 for purposes of explanation and is not intended to limit the subject matter described herein in any way. In this regard, while FIG. 3 depicts various elements of the media device 300 as being realized using separate or distinct components, in practice, the features and/or functionality of multiple elements may be integrated or otherwise combined and implemented using a common element or structure. For example, one or more of the transcoding module 306 and the tuner management module 314 may be implemented by or otherwise combined with the device management module 310, in which case, a separate transcoding module 306 or tuner management module 314 may not be present.

It should be noted that the general systems, structures and techniques described above may be inter-combined, enhanced, modified and/or otherwise implemented to provide any number of different features. In particular, the term “exemplary” is used herein to represent one example, instance or illustration that may have any number of alternates. Any implementation described herein as “exemplary” should not necessarily be construed as preferred or advantageous over other implementations.

For the sake of brevity, conventional techniques related to broadcasting, streaming, networking, content distribution or delivery, communications standards or protocols, encoding/decoding standards or protocols, content formats, and other functional aspects of the systems (and the individual operating components of the systems) may not be described in detail herein. The subject matter may be described herein in terms of functional and/or logical block components, and with reference to symbolic representations of operations, processing tasks, and functions that may be performed by various computing components or devices. It should be appreciated that in alternative embodiments the various block components shown in the figures may be equivalently realized by any number of components configured to perform the specified functions. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus is not intended to be limiting. For example, terms such as “first,” “second” and other such numerical terms referring to structures do not imply a sequence or order unless clearly indicated by the context.

While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents. Accordingly, details of the exemplary embodiments or other limitations described above should not be read into the claims absent a clear intention to the contrary.

1. A method of presenting media content using a media device, the method comprising:
obtaining, by a tuner at the media device, the media content broadcast on a broadcast channel;
buffering, at the media device, a recent subset of the media content in a buffer associated with the tuner, resulting in a buffered subset of the media content; and
in response to selection of the broadcast channel for presentation on a destination device coupled to the media device:
transcoding, at the media device, at least a portion of the buffered subset of the media content from a broadcast format to a different format at a data rate faster than a real-time transcoding rate, resulting in a transcoded subset of the buffered subset of the media content having the different format; and
providing, by the media device, the transcoded subset of the media content to the destination device.

2. The method of claim 1, further comprising initializing, at the media device, a time shift buffer with the buffered subset of the media content from the buffer associated with the tuner prior to filling the time shift buffer with the media content broadcast on the broadcast channel from the tuner.

3. The method of claim 2, wherein transcoding comprises:
locating a key frame within the buffered subset of the media content in the time shift buffer; and
transcoding the media content in the time shift buffer in a time sequential manner starting from the key frame.

4-5. (canceled)

6. The method of claim 2, further comprising identifying a key frame within the buffered subset of the media content in the buffer associated with the tuner prior to initializing the time shift buffer, wherein initializing the time shift buffer comprises initializing the time shift buffer with the portion of the buffered subset of the media content including the key frame while excluding a remaining portion of the buffered subset of the media content preceding the key frame.

7. The method of claim 1, wherein providing the transcoded subset of the media content to the destination device comprises transmitting the transcoded subset of the media content to the destination device over a communications network at a data rate faster than a real-time transmission rate.

8. The method of claim 1, further comprising:
identifying the broadcast channel from among a plurality of broadcast channels available at the media device based at least in part on a viewing history associated with a user of the destination device; and
allocating the tuner to the broadcast channel in response to identifying the broadcast channel prior to obtaining the media content broadcast on the broadcast channel.

9. The method of claim 1, further comprising:
obtaining, by a second tuner at the media device, second media content broadcast on a second broadcast channel different from the broadcast channel; and
providing, by the media device, the second media content to the destination device prior to the selection of the broadcast channel, wherein buffering the recent subset of the media content in the buffer associated with the tuner comprises buffering the media content on the broadcast channel in the background while the second media content is provided to the destination device.

10. A media device comprising:
a tuner to receive media content on a broadcast channel;
a tuner buffer coupled to the tuner to buffer a recent subset of the media content on the broadcast channel;
a time shift buffer;
a management module coupled to the tuner buffer and the time shift buffer to initialize the time shift buffer with the recent subset of the media content on the broadcast channel from the tuner buffer in response to selection of the broadcast channel; and
a transcoding module coupled to the time shift buffer to transcode at least a portion of the recent subset of the media content from the time shift buffer from a broadcast format to a different format at a data rate faster than a real-time transcoding rate.

11. (canceled)

12. The media device of claim 10, further comprising an output interface coupled to the transcoding module to transmit the transcoded portion of the recent subset of the media content to a destination device.

13. The media device of claim 10, wherein the management module is coupled to the tuner and the transcoding module to fill the time shift buffer with the media content from the tuner in real-time after initializing the time shift buffer and configure the transcoding module to transcode the media content in the time shift buffer at the data rate faster than the real-time transcoding rate until reaching live media content.

14. The media device of claim 13, further comprising an output interface coupled to the transcoding module to transmit the transcoded portion of the recent subset of the media content to a destination device over a communications network at a second data rate faster than a real-time transmission rate.

15. A media device comprising:
a tuner arrangement comprising a plurality of tuners;
a data storage arrangement comprising a plurality of tuner buffers corresponding to the plurality of tuners and a time shift buffer; and
a management module coupled to the data storage arrangement to initialize the time shift buffer with a buffered subset of media content from a first tuner buffer of the plurality of tuner buffers prior to feeding the time shift buffer with the media content from a first tuner associated with the first tuner buffer in real-time in response to user selection of a broadcast channel associated with the first tuner and transcode at least a portion of the buffered subset of media content in the time shift buffer from a broadcast format to a different format at a data rate faster than a real-time transcoding rate.

16. The media device of claim 15, wherein the data storage arrangement comprises a first data storage element providing the plurality of tuner buffers and a second data storage element providing the time shift buffer.

17. The media device of claim 16, wherein the first data storage element comprises a random access memory (RAM) and the second data storage element comprises a hard disk drive (HDD).

18. The media device of claim 15, wherein the management module is configured to assign the plurality of tuners to a plurality of different broadcast channels based at least in part on a viewing history associated with a user.

19. (canceled)

20. The media device of claim 19, transcoding the portion of buffered subset of media content in the time shift buffer resulting in a transcoded buffered subset of the media content on a first broadcast channel assigned to the first tuner, wherein the management module is configured to transmit the transcoded buffered subset to a destination device over a communications network at a second data rate faster than a real-time transmission rate.

21. The method of claim 1, further comprising analyzing the buffered subset of the media content to identify a key frame, wherein:
the media content comprises live broadcast media content; and
transcoding at least the portion of the buffered subset of the media content comprises transcoding the portion of the buffered subset of the media content following the key frame prior to receiving a subsequent key frame in the live broadcast media content.

22. The method of claim 1, wherein transcoding at least the portion of the buffered subset of the media content comprises transcoding the portion of the buffered subset of the media content at the data rate faster than the real-time transcoding rate until reaching a most recent key frame and reverting to the real-time transcoding rate.

23. The method of claim 1, wherein transcoding at least the portion of the buffered subset of the media content comprises transcoding the portion of the buffered subset of the media content into a media content transport stream encoded in accordance with a communications protocol at the data rate faster than the real-time transcoding rate.

24. The method of claim 1, wherein transcoding at least the portion of the buffered subset of the media content comprises transcoding the portion of the buffered subset of the media content directly from a tuner buffer without loading the buffered subset of the media content to a time shift buffer.
